(19) United States
(12) Patent Application Publication
(10) Pub. No.: US 2026/0291553 A1
(43) Pub. Date: Sep. 24, 2026

(54) INFORMATION PROCESSING METHODS, SYSTEM AND APPARATUSES, COMMUNICATION DEVICE AND STORAGE MEDIUM

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/469,243

(22) PCT Filed: Mar. 31, 2023
(86) PCT No.: PCT/CN2023/085483

§ 371 Date: Sep. 25, 2025

(51) Int. Cl. H04B 7/0413; H04W 72/12; H04W 72/51

(52) U.S. Cl. CPC H04B 7/0413; H04W 72/12; H04W 72/51

(57) ABSTRACT

The embodiments of the present disclosure provide information processing methods, system and apparatuses, a communication device and a storage medium. An information processing method is executed by a terminal, and the method comprises: sending capability information, the capability information indicating whether the terminal has the capability of keeping the power parameter unchanged with respect to switching of the number of multiple input multiple output (MIMO) layers; and, in response to scheduling based on the capability information by a network device, communicating with the network device.

### CROSS-REFERENCE TO RELATED APPLICATION

The application is a U.S. National Stage of International Application No. PCT/CN2023/085483 filed on Mar. 31, 2023, the entire content of which is incorporated herein by reference.

### TECHNICAL FIELD

The present disclosure relates to the technical field of wireless communication but is not limited to the technical field of wireless communication, and in particular, to an information processing method, system and apparatus, a communication device and a storage medium.

### BACKGROUND

Due to the enhancement of radio frequency (RF) capability, terminals can support uplink multi-antenna transmission in some scenarios. Accordingly, under certain channel conditions, they can also support changes in the number of multiple input multiple output (MIMO) layers (MIMO layer number).

### SUMMARY

Embodiments of the present disclosure provide an information processing method, system and apparatus, a communication device and a storage medium.

A first aspect of an embodiment of the present disclosure provides an information processing method, which is performed by a terminal. The method includes:
sending capability information, where the capability information indicates whether the terminal has a capability of keeping a power parameter unchanged during switching of a MIMO layer number; and
in response to scheduling of a network device based on the capability information, communicating with the network device.

A second aspect of the present disclosure provides an information processing method, which is performed by a network device. The method includes:
receiving capability information, where the capability information indicates whether the terminal has a capability of keeping a power parameter unchanged during switching of a MIMO layer number; and
scheduling the terminal based on the capability information.

A third aspect of the present disclosure provides an information processing method, which is performed by an information processing system, where the information processing system includes: a terminal and a network device. The method includes:
the terminal sending capability information to the network device, where the capability information indicates whether the terminal has a capability of keeping a power parameter unchanged during switching of a MIMO layer number; and in response to scheduling of the network device based on the capability information, communicating with the network device;
the network device receiving the capability information and scheduling the terminal based on the capability information.

A fourth aspect of the embodiments of the present disclosure provides an information processing system, the system including: a terminal and a network device;
the terminal is configured to execute the method described in the first aspect;
the network device is configured to execute the method described in the second aspect.

A fifth aspect of the present disclosure provides an information processing apparatus, which is applied to a terminal. The apparatus includes:
a processing module, configured to send capability information, where the capability information indicates whether the terminal has a capability of keeping a power parameter unchanged during switching of a MIMO layer number; and in response to scheduling of a network device based on the capability information, communicate with the network device.

A sixth aspect of the present disclosure provides an information processing apparatus, which is applied to a network device. The apparatus includes:
a processing module, configured to receive capability information, where the capability information indicates whether a terminal has a capability of keeping a power parameter unchanged during switching of a MIMO layer number; and schedule the terminal based on the capability information.

A seventh aspect of the embodiments of the present disclosure provides a communication device, including a processor, a transceiver, a memory, and an executable program stored in the memory and capable of being run by the processor, where the processor executes the information processing method described in any of the preceding embodiments when running the executable program.

An eighth aspect of the embodiments of the present disclosure provides a computer storage medium, where the computer storage medium stores an executable program; after the executable program is executed by a processor, the information processing method described in any of the aforementioned embodiments can be implemented.

It should be understood that the foregoing general description and the following detailed description are exemplary and explanatory only and are not restrictive of the embodiments of the present disclosure.

### BRIEF DESCRIPTION OF THE DRAWINGS

The accompanying drawings, which are incorporated in and constitute a part of this specification, illustrate embodiments consistent with the present disclosure and, together with the specification, serve to explain the principles of the embodiments of the present disclosure.

FIG. 1 is a schematic structural diagram of a wireless communication system according to an embodiment;

FIG. 2 is a flowchart of an information processing method according to an embodiment;

FIG. 3 is a schematic diagram showing a MIMO antenna configuration according to an embodiment;

FIG. 4 is a schematic diagram showing a MIMO antenna configuration according to an embodiment;

FIG. 5 is a flowchart of an information processing method according to an embodiment;

FIG. 6 is a flowchart of an information processing method according to an embodiment;

FIG. 7 is a flowchart of an information processing method according to an embodiment;

FIG. 8 is a schematic diagram showing an interaction in an information processing method according to an embodiment;

FIG. 9 is a schematic structural diagram of an information processing apparatus according to an embodiment;

FIG. 10 is a schematic structural diagram of an information processing apparatus according to an embodiment;

FIG. 11 is a schematic structural diagram of a terminal according to an embodiment;

FIG. 12 is a schematic structural diagram of a communication device according to an embodiment.

### DETAILED DESCRIPTION

Here, embodiments are described in detail, examples of which are shown in the accompanying drawings. When the following description refers to the drawings, unless otherwise indicated, the same numbers in different drawings represent the same or similar elements. The implementations described in the following embodiments do not represent all implementations consistent with the embodiments of the present disclosure. Instead, they are only examples of apparatuses and methods consistent with some aspects of the embodiments of the present disclosure.

The terms used in the embodiments of the present disclosure are only for the purpose of describing specific embodiments, and are not intended to limit the embodiments of the present disclosure. The singular forms of “a/an”, “said”, and “the” used in the present disclosure are also intended to include plural forms, unless the context clearly indicates other meanings. It should also be understood that the term “and/or” used in the present disclosure refers to and includes any or all possible combinations of one or more associated listed items.

It should be understood that although the terms first, second, third, etc. may be used to describe various information in the embodiments of the present disclosure, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “at the time of” or “when” or “in response to determining”.

Referring to FIG. 1, FIG. 1 shows a schematic structural diagram of a wireless communication system provided by the embodiments of the present disclosure. As shown in FIG. 1, the wireless communication system is a communication system based on cellular mobile communication technology, and the wireless communication system may include: a plurality of terminals 11 and a plurality of access devices 12.

The terminal 11 may be a device that provides voice and/or data connectivity to the user. The terminal 11 can communicate with one or more core networks via a radio access network (RAN). The terminal 11 may be an Internet of Things terminal, such as a sensor device, a mobile phone (or a “cellular” phone), and a computer with an Internet of Things terminal. For example, it may be a fixed, portable, pocket-sized, handheld, computer-built-in or vehicle-mounted apparatus, such as a station (STA), a subscriber unit, a subscriber station, a mobile station, a mobile, a remote station, an access point, a remote terminal, an access terminal, a user device, a user agent, a user equipment (UE), or a user terminal. In an embodiment, the terminal 11 may also be a device of an unmanned aerial vehicle. In an embodiment, the terminal 11 may be a vehicle-mounted device, such as a driving computer with wireless communication function, or a wireless communication device external to the driving computer. In an embodiment, the terminal 11 may be a roadside device, such as a street lamp, signal lamp or other roadside device with wireless communication function.

The access device 12 may be a network node device in the wireless communication system. The wireless communication system may be the 4th generation mobile communication (4G) system, also known as a long term evolution (LTE) system; or, the wireless communication system may be a 5G system, also known as a new radio (NR) system or a 5G NR system. In an embodiment, the wireless communication system may be a next generation system of the 5G system. The access network in the 5G system may be called a new generation-radio access network (NG-RAN). In an embodiment, it may be an MTC system.

The access device 12 may be an evolved access device (eNB) used in the 4G system. In an embodiment, the access device 12 may also be an access device (gNB) that adopts a centralized distributed architecture in the 5G system. When the access device 12 adopts the centralized distributed architecture, it usually includes a central unit (CU) and at least two distributed units (DUs). The central unit is provided with protocol stacks of a packet data convergence protocol (PDCP) layer, a radio link layer control protocol (Radio Link Control, RLC) layer, and a media access control (MAC) layer; the distributed unit is provided with a physical (Physical, PHY) layer protocol stack. The specific implementation method of the access device 12 is not limited in the embodiments of the present disclosure.

A wireless connection can be established between the access device 12 and the terminal 11 through a wireless air interface. In different implementations, the wireless air interface is a wireless air interface based on the fourth generation mobile communication network technology (4G) standard; or, the wireless air interface is a wireless air interface based on the fifth generation mobile communication network technology (5G) standard, for example, the wireless air interface is a new air interface; or, the wireless air interface may also be a wireless air interface based on the next generation mobile communication network technology standard of 5G.

Optionally, the above-mentioned wireless communication system may further include a network management device 13. Several access devices 12 are respectively connected to the network management device 13. The network management device 13 may be a core network device in the wireless communication system, for example, the network management device 13 may be a mobility management entity (MME) in an evolved packet core (EPC). In an embodiment, the network management device may also be other core network devices, such as a serving gateway (SGW), a public data network gateway (PGW), a policy and charging rules function (PCRF) or a home subscriber server (HSS). The embodiment of the present disclosure does not limit the implementation form of the network management device 13.

In an embodiment, the terminal 11 may be a terminal in the embodiments of the present disclosure, and the terminal may include a user equipment (UE). The UE may include but is not limited to: a mobile phone, a wearable device, a vehicle terminal, a road side unit (RSU), a smart home terminal, an industrial sensor device and/or a medical device, etc. The access device 12 may be a network device in the embodiments of the present disclosure, such as a base station.

During the change of the MIMO layer number, there are still some deficiencies in the scheduling procedure of the base station for the terminal.

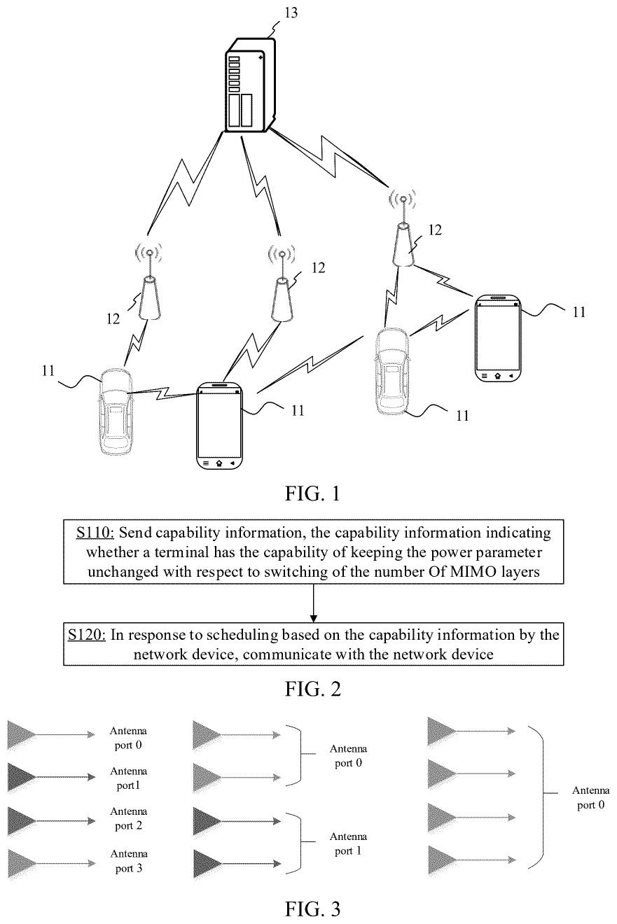

As shown in FIG. 2, an embodiment of the present disclosure provides an information processing method, which is performed by a terminal, and the method includes the following steps.
In S110: capability information is sent; where the capability information indicates whether the terminal has a capability of keeping a power parameter unchanged during switching of a MIMO layer number.
In S120: in response to scheduling of the network device based on the capability information, the network device is communicated with.

In the embodiments of the present disclosure, the capability information may include one or more indication fields, indication bits or other forms of content, which are used to indicate whether the terminal has a capability of keeping the power parameter unchanged during switching of the MIMO layer number. For example, the capability information may be 1 bit. For example, when the bit is 1, it indicates that the terminal has the above capability, and when the bit is 0, it indicates that the terminal does not have the above capability. It can be understood that the capability information may also be in any other form, which is not specifically limited here.

In one embodiment, the MIMO layer number may be the number of uplink MIMO layers, which may indicate the number of data streams simultaneously transmitted in uplink transmission of the terminal, etc. The maximum MIMO layer number that the terminal can support under different channel conditions may be different. For example, the better the channel condition, the larger the maximum MIMO layer number that the terminal can support.

For example, when the channel condition is good, the terminal can support a maximum of 4 MIMO layers; when the channel condition is poor, the maximum MIMO layer number that the terminal can support may be reduced to 2 layers, and so on.

In one embodiment, the power parameter may indicate the transmit power of the terminal. In an embodiment, the power parameter may include at least one of the maximum power level, average power level, maximum power value, and average power value of the terminal. The power parameter remains unchanged during switching of the MIMO layer number, which may mean that the terminal maintains the maximum power unchanged during switching of the MIMO layer number, for example, the maximum power level remains unchanged.

In an embodiment, in the case that the terminal has the capability of keeping the power parameter unchanged during switching of the MIMO layer number, when the terminal supports a maximum of 8 MIMO layers, the maximum power level that can be supported is Power Class (PC) 1.5, and when the maximum MIMO layer number supported by the terminal is reduced to 4 or 2 layers, etc., the maximum power level of PC1.5 can still be supported.

In one embodiment, the terminal may also send a power parameter, which may be a power parameter corresponding to the above-mentioned capability, such as a maximum power level, etc., so that the network side can better determine the capability of the terminal.

Optionally, the power parameter may be sent in the same signaling as the capability information, or may be sent separately in a different signaling. The power parameter may be sent simultaneously with the capability information, or may not be sent simultaneously.

In one embodiment, the terminal may also send a first MIMO layer number to the network device, where the first MIMO layer number is the maximum MIMO layer number supported by the terminal. At this time, the capability information indicates whether the terminal has the capability of keeping the power parameter unchanged when the MIMO layer number is less than or equal to the first MIMO layer number.

For example, when the terminal reports that the first MIMO layer number is 4 layers, and the reported capability information indicates that the terminal has the capability of keeping the power parameter unchanged when the MIMO layer number is switched, it means that when the MIMO layer number is switched to a layer number lower than the first MIMO layer number, for example, switching to 2 layers or 1 layer, the terminal can keep the power parameter unchanged.

In one embodiment, the first MIMO layer number may be sent in the same signaling as the capability information, or may be sent separately in a different signaling. The first MIMO layer number may be sent simultaneously with the capability information, or they may be sent at different times.

In one embodiment, the first MIMO layer number may be the maximum MIMO layer number currently supported by the terminal.

In one embodiment, when the maximum MIMO layer number supported by the terminal changes, or when the number of MIMO layers currently used by the terminal changes, the first MIMO layer number is sent.

In one embodiment, sending the capability information may include sending the capability information when the maximum MIMO layer number supported by the terminal changes, or when the number of MIMO layers currently used by the terminal changes.

In one embodiment, sending the capability information may include: sending the capability information when the current number of MIMO layers of the terminal is greater than or equal to a given value, where the given value may be 2, 4, or 6, etc.

In an embodiment, the given value is 2, indicating that the terminal sends the capability information when the current number of MIMO layers is greater than or equal to 2, so that the network side can determine the capability information of the terminal when there is a possibility of MIMO layer number changes.

In one embodiment, the current number of MIMO layers of the terminal may be the maximum MIMO layer number currently supported by the terminal, or may be less than the maximum MIMO layer number currently supported by the terminal, that is, the first MIMO layer number.

In one embodiment, the capability information includes: first capability information indicating that the terminal has the capability of keeping the power parameter unchanged during switching of the MIMO layer number, or second capability information indicating that the terminal does not have the capability of keeping the power parameter unchanged during switching of the MIMO layer number. The terminal may send the first capability information when it has the above capability, and may not send the first capability information when it does not have the above capability, for example, send the second capability information.

In one embodiment, the capability information further indicates the maximum MIMO layer number that the terminal supports with the power parameter remaining unchanged during switching of the MIMO layer number. For example, when the capability information indicates that the terminal has the above capability, the capability information may indicate the maximum MIMO layer number that the terminal supports for the above capability, i.e., the second MIMO layer number. For example, the second MIMO layer number may be recorded as one field in the capability information.

In one embodiment, when the capability information indicates that the terminal has a capability of keeping the power parameter unchanged during switching of the MIMO layer number, for example, when step S110 is sending the first capability information, the method may also include: sending a second MIMO layer number; where the second MIMO layer number is the maximum MIMO layer number that the terminal supports the capability of keeping the power parameter unchanged during switching of the MIMO layer number.

Here, the second MIMO layer number is the maximum MIMO layer number corresponding to the capability supported by the terminal, and the first MIMO layer number is the maximum MIMO layer number supported by the terminal. That is, the second MIMO layer number may be the same as the first MIMO layer number, or it may be lower than the first MIMO layer number. For example, when the maximum MIMO layer number supported by the terminal is 8 layers, that is, when the first MIMO layer number is 8, the terminal can support keeping the power parameter unchanged during the switching of the MIMO layer number up to a maximum of 8 layers, that is, the second MIMO layer number is 8, and at this time, the terminal can keep the power parameter unchanged in the switching of 8 layers, 4 layers, and 2 layers, etc., which does not exceed 8 layers. In an embodiment, when the maximum MIMO layer number supported by the terminal is 8 layers, that is, when the first MIMO layer number is 8, the terminal can also only support keeping the power parameter unchanged during the switching of the MIMO layer number up to a maximum of 4 layers, that is, the second MIMO layer number is 4, and at the same time, the terminal can only keep the power parameter unchanged during the switching of 4 layers and 2 layers, etc., which does not exceed 4 layers, and cannot keep the power parameter unchanged during the switching of more than 4 layers, such as 6 layers or 8 layers.

In one embodiment, the second MIMO layer number may be sent in the same signaling as the capability information, or may be sent separately in different signaling. The second MIMO layer number may be sent simultaneously with the capability information, or they may be sent at different times.

In one embodiment, step S110 may include: sending the first capability information in the case of determining that the terminal does not send the first capability information when the maximum MIMO layer number supported by the terminal is higher than the maximum MIMO layer number currently supported.

In one embodiment, step S110 may include: in the case of determining that the terminal does not send the first capability information when the maximum MIMO layer number supported is higher than the maximum MIMO layer number currently supported, sending the first capability information when the current terminal has the capability of keeping the power parameter unchanged during switching of the MIMO layer number.

In one embodiment, S110 may include: when it is determined that the maximum MIMO layer number supported by the terminal is a third MIMO layer number, and when the maximum MIMO layer number currently supported by the terminal is less than the third MIMO layer number and the terminal has the capability of keeping the power parameter unchanged during switching of the MIMO layer number, sending the first capability information.

In one embodiment, S110 may include: determining whether the terminal has sent the second capability information or not sent the first capability information when the maximum MIMO layer number supported is the third MIMO layer number; in response to that the terminal has sent the second capability information or not sent the first capability information when the maximum MIMO layer number supported is the third MIMO layer number, sending the first capability information when the maximum MIMO layer number currently supported by the terminal is less than the third MIMO layer number and the terminal has the capability of keeping the power parameter unchanged during switching of the MIMO layer number.

In an embodiment, when the third MIMO layer number is 8, that is, when the terminal supports a maximum MIMO layer number of 8 layers, the first capability information is not sent, for example, the second capability information is sent, which indicates that the terminal does not have the capability of keeping the power parameter unchanged during switching of the MIMO layer number when the maximum MIMO layer number is 8 layers. Therefore, when the maximum MIMO layer number supported by the terminal is lower than 8 layers, for example, 4 layers, if the terminal has the capability of keeping the power parameter unchanged during switching of the MIMO layer number when the maximum MIMO layer number is 4 layers, the first capability information can be sent. At this time, it can indicate that the terminal can keep the power parameter unchanged during switching of the MIMO layer number with the maximum MIMO layer number of 4 layers, but does not have the capability of keeping the power parameter unchanged during switching of the MIMO layer number higher than 4 layers.

In one embodiment, the method may further include: if it is determined that the terminal has sent the first capability information when the maximum MIMO layer number supported is higher than the maximum MIMO layer number currently supported, not sending the capability information.

In one embodiment, the method may further include: in response to that the terminal has sent the first capability information when the maximum MIMO layer number supported is the third MIMO layer number, not sending capability information when the maximum MIMO layer number currently supported by the terminal is less than the third MIMO layer number.

In an embodiment, when the third MIMO layer number is 8, that is, the terminal has sent the first capability information when the maximum MIMO layer number supported is 8 layers, it indicates that the terminal has the capability of keeping the power parameter unchanged during switching of the MIMO layer number with a maximum MIMO layer number of 8 layers. At this time, it can be assumed that the terminal also has this capability during switching of the MIMO layer number with a maximum MIMO layer number lower than 8 layers, such as 4 layers. At this time, there is no need to send the capability information, thereby reducing unnecessary signaling overhead and resource occupancy.

In one embodiment, step S120 may include: determining an uplink MIMO antenna configuration scheduled by the network device based on the capability information; and communicating with the network device based on the uplink MIMO antenna configuration. The scheduled uplink MIMO antenna configuration may match the capability information, for example, the first capability information matches the first uplink MIMO antenna configuration, and the second capability information matches the second uplink MIMO antenna configuration.

In an embodiment, when the first capability information is reported, the scheduled uplink MIMO antenna configuration may be as shown in FIG. 3, which, from left to right, respectively includes uplink transmission of 4 data streams through 4 antenna ports in 4-layer MIMO, uplink transmission of 4 data streams through 2 antenna ports in 2-layer MIMO, and uplink transmission of 4 data streams through 1 antenna port in 1-layer MIMO.

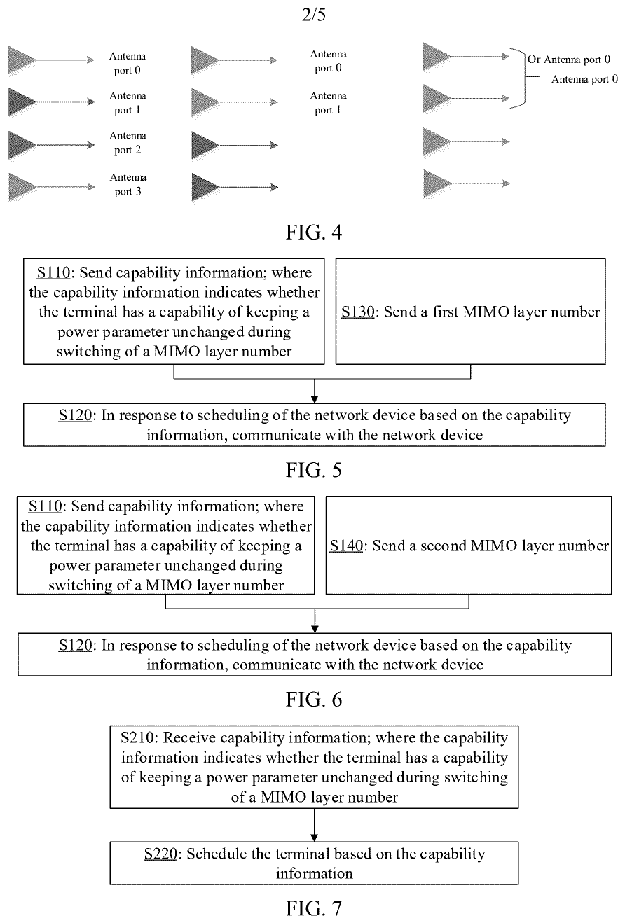

In an embodiment, when the second capability information is reported, the scheduled uplink MIMO antenna configuration may be as shown in FIG. 4, which includes, from left to right, uplink transmission of 4 data streams through 4 antenna ports in case of 4-layer MIMO, uplink transmission of 2 data streams through 2 antenna ports in case of 2-layer MIMO, and uplink transmission of 1 or 2 data streams through 1 antenna port in case of 1-layer MIMO, where 2 data streams are transmitted upstream through 1 antenna port when the terminal supports transmit diversity (TxD), and 1 data stream is transmitted upstream through 1 antenna port when TxD is not supported.

In one embodiment, when the first MIMO layer number is reported, the scheduled uplink MIMO antenna configuration may match the first MIMO layer number and the capability information. For example, different first MIMO layer numbers may correspond to different uplink MIMO antenna configurations.

In one embodiment, when the second MIMO layer number is reported, the scheduled uplink MIMO antenna configuration may match the second MIMO layer number and the capability information. For example, different uplink MIMO antenna configurations may correspond to different second MIMO layer numbers.

In one embodiment, communicating with the network device may include transmitting data upstream to the network device.

In this way, the terminal can report whether it can keep its power unchanged during switching of the MIMO layer number, so that the network device can schedule the terminal more accurately according to the terminal capability to improve the efficiency of communication between the terminal and the network device. In addition, the system capacity and coverage can also be improved based on MIMO layer number switching.

In some embodiments, as shown in FIG. 5, the method may further include the following steps.
In S130, a first MIMO layer number is sent.

The first MIMO layer number is the maximum MIMO layer number supported by the terminal; the capability information indicates whether the terminal has a capability of keeping the power parameter unchanged when the MIMO layer number is less than or equal to the first MIMO layer number.

In the embodiments of the present disclosure, step S130 can be executed simultaneously with step S110, or they can be executed one after the other. The execution order can be arbitrarily exchanged, or the first MIMO layer number sent can be carried in the capability information, or can be carried together with the capability information by the same signaling or different signaling, etc., and no specific restrictions are made here.

In one embodiment, the first MIMO layer number is sent within a predetermined time window for sending the capability information, where the predetermined time window may be before or after sending the capability information, and the length of the predetermined time window may be preset, determined according to a protocol, or determined according to negotiation with the network device or determined according to the channel condition, for example, it may be 10 ms, 100 ms or 200 ms, etc.

For example, when the terminal reports that the first MIMO layer number is 4 layers, and the reported capability information indicates that the terminal has the capability of keeping the power parameter unchanged when the MIMO layer number is switched, it means that when the MIMO layer number is switched to a layer number lower than the first MIMO layer number, for example, switching to 2 layers or 1 layer, the terminal can keep the power parameter unchanged.

In one embodiment, the first MIMO layer number may be sent in the same signaling as the capability information, or they may be sent separately in different signalings. The first MIMO layer number may be sent simultaneously with the capability information, or they may be sent at different times.

In one embodiment, the first MIMO layer number may be the maximum MIMO layer number currently supported by the terminal.

In one embodiment, when the maximum MIMO layer number supported by the terminal changes, or when the number of MIMO layers currently used by the terminal changes, the first MIMO layer number is sent.

In this way, by reporting the capability information and the first MIMO layer number, the network device can be informed whether the terminal has the above capability during switching of the MIMO layer number corresponding to the first MIMO layer number, so that the network device can know the capability of the terminal more accurately.

In some embodiments, sending capability information includes:
when the current MIMO layer number of the terminal is greater than or equal to a given value, sending the capability information.

In one embodiment, the capability information includes:
first capability information indicating that the terminal has the capability of keeping the power parameter unchanged during the switching of the MIMO layer number, or second capability information indicating that the terminal does not have the capability of keeping the power parameter unchanged during the switching of the MIMO layer number.

In one embodiment, sending the capability information, for example, sending the capability information when the current MIMO layer number of the terminal is greater than or equal to a given value, may include:
determining whether the terminal has sent the second capability information or has not sent the first capability information when the maximum MIMO layer number supported is a third MIMO layer number;
in response to the terminal sending the second capability information or not sending the first capability information when the maximum MIMO layer number supported is the third MIMO layer number, sending the first capability information when the maximum MIMO layer number currently supported by the terminal is less than the third MIMO layer number and the terminal has the capability of keeping the power parameter unchanged during switching of the MIMO layer number.

In one embodiment, the third MIMO layer number can be determined based on the maximum MIMO layer number currently supported, for example, the third MIMO layer number is greater than the maximum MIMO layer number currently supported. In an embodiment, when the maximum MIMO layer number currently supported is 4 layers, the third MIMO layer number may be 8 layers.

In one embodiment, determining whether the terminal has sent the second capability information or not sent the first capability information when the maximum MIMO layer number supported is the third MIMO layer number may be determining whether the terminal has sent the second capability information or not sent the first capability information when the maximum MIMO layer number supported is the third MIMO layer number within a predetermined period before the current moment, where the third MIMO layer number is greater than the maximum MIMO layer number currently supported.

In one embodiment, the method may further include:
in response to the terminal sending the first capability information when the maximum MIMO layer number supported is the third MIMO layer number, not sending the capability information when the maximum MIMO layer number currently supported by the terminal is less than the third MIMO layer number.

In this way, by supporting the capability of keeping power parameter unchanged during switching of the MIMO layer number when the maximum MIMO layer number is large, it can be assumed that this capability is also available when the maximum MIMO layer number supported is small, and the first capability information is reported only when this capability is not available when the maximum MIMO layer number supported is large, thereby reducing the number of times the capability information is reported, and reducing signaling overhead and channel resource occupancy.

In some embodiments, when the capability information indicates that the terminal has the capability of keeping the power parameter unchanged during switching of the MIMO layer number, as shown in FIG. 6, the method may further include the following step.
In S140: a second MIMO layer number is sent.

The second MIMO layer number is a maximum MIMO layer number that the terminal supports the capability of keeping the power parameter unchanged during switching of the MIMO layer number.

Here, the second MIMO layer number is the maximum MIMO layer number corresponding to the terminal's support for this capability, and the first MIMO layer number is the maximum MIMO layer number supported by the terminal. That is, the second MIMO layer number may be the same as the first MIMO layer number, or it may be lower than the first MIMO layer number. For example, when the maximum MIMO layer number supported by the terminal is 8 layers, that is, when the first MIMO layer number is 8, the terminal can support keeping the power parameter unchanged during switching of the MIMO layer number of the maximum 8 layers. That is, the second MIMO layer number is 8. At this time, the terminal can keep the power parameter unchanged during switching up to 8 layers, including 8 layers, 4 layers, and 2 layers. In an embodiment, when the maximum MIMO layer number supported by the terminal is 8 layers, that is, when the first MIMO layer number is 8, the terminal may also only support keeping the power parameter unchanged in the switching of MIMO layers with a maximum of 4 layers, that is, the second MIMO layer number is 4. At this time, the terminal can only keep the power parameter unchanged in the switching of 4 layers and 2 layers, etc., which does not exceed 4 layers, and cannot keep the power parameter unchanged in the switching of more than 4 layers, such as 6 layers or 8 layers.

In one embodiment, the second MIMO layer number may be sent in the same signaling as the capability information, or they may be sent separately in different signalings. The second MIMO layer number may be sent simultaneously with the capability information, or they may be sent at different times.

In this way, by reporting the capability information and the maximum MIMO layer number that the terminal supports for the capability, the network device can learn in which MIMO layers the terminal has the above capability, thereby scheduling the terminal more accurately.

In some embodiments, step S120 may include:
determining an uplink MIMO antenna configuration scheduled by the network device based on the capability information;
communicating with the network device based on the uplink MIMO antenna configuration.

In one embodiment, the scheduled uplink MIMO antenna configuration may match the capability information, for example, the first capability information matches the first uplink MIMO antenna configuration, and the second capability information matches the second uplink MIMO antenna configuration. The antenna configuration may include an antenna port configuration, etc.

In an embodiment, when the first capability information is reported, the scheduled uplink MIMO antenna configuration may be as shown in FIG. 3. When the second capability information is reported, the scheduled uplink MIMO antenna configuration may be as shown in FIG. 4.

In one embodiment, when the first MIMO layer number is reported, the scheduled uplink MIMO antenna configuration may match the first MIMO layer number and the capability information. For example, different first MIMO layer numbers may correspond to different uplink MIMO antenna configurations.

In one embodiment, when the second MIMO layer number is reported, the scheduled uplink MIMO antenna configuration may match the second MIMO layer number and the capability information. For example, different uplink MIMO antenna configurations may correspond to different second MIMO layer numbers.

As shown in FIG. 7, an embodiment of the present disclosure provides an information processing method, which is executed by a network device. The method includes the following steps.
In S210: capability information is received; where the capability information indicates whether the terminal has a capability of keeping a power parameter unchanged during switching of a MIMO layer number.
In S220: the terminal is scheduled based on the capability information.

In the embodiments of the present disclosure, the network device may be a base station, etc. Scheduling the terminal based on the capability information may be scheduling the uplink MIMO antenna configuration of the terminal based on the capability information. For example, the uplink MIMO antenna configuration scheduled when the capability information indicates that the terminal has the above capability is different from the uplink MIMO antenna configuration scheduled when the capability information indicates that the terminal does not have the above capability.

In an embodiment, when the first capability information is reported, the scheduled uplink MIMO antenna configuration may be as shown in FIG. 3. When the second capability information is reported, the scheduled uplink MIMO antenna configuration may be as shown in FIG. 4.

In one embodiment, the capability information further indicates the maximum MIMO layer number that the terminal supports the capability of keeping the power parameter unchanged during the switching of the MIMO layer number.

It should be noted that for the contents corresponding to or repeated in the aforementioned embodiments, the steps and optional implementations on the terminal side may be referred to, which are not repeated here.

In one embodiment, when the first MIMO layer number is reported, the scheduled uplink MIMO antenna configuration may match the first MIMO layer number and the capability information. For example, different first MIMO layer numbers may correspond to different uplink MIMO antenna configurations.

In one embodiment, when the second MIMO layer number is reported, the scheduled uplink MIMO antenna configuration may match the second MIMO layer number and the capability information. For example, different uplink MIMO antenna configurations may correspond to different second MIMO layer numbers.

In some embodiments, the method further includes:
receiving a first MIMO layer number; where the first MIMO layer number is the maximum MIMO layer number supported by the terminal; and the capability information indicates whether the terminal has the capability of keeping the power parameter unchanged when the MIMO layer number is less than or equal to the first MIMO layer number.

In one embodiment, the first MIMO layer number may be received together with the capability information. For example, the first MIMO layer number may be carried in the capability information, or may be carried by the same signaling as the capability information, or may be carried by different signaling from the capability information. Receiving the first MIMO layer number may be performed before or after receiving the capability information, or simultaneously with receiving the capability information.

In some embodiments, the capability information is sent by the terminal when the current MIMO layer number is greater than or equal to a given value.

In some embodiments, the capability information includes:
first capability information indicating that the terminal has the capability of keeping the power parameter unchanged during the switching of the MIMO layer number, or second capability information indicating that the terminal does not have the capability of keeping the power parameter unchanged during the switching of the MIMO layer number.

In some embodiments, the method further includes:
in response to receiving the first capability information, determining that the maximum MIMO layer number currently supported by the terminal is less than the third MIMO layer number, and the terminal has a capability of keeping the power parameter unchanged during switching of the MIMO layer number; where the network device receives the second capability information or does not receive the first capability information when the maximum MIMO layer number supported by the terminal is the third MIMO layer number.

In some embodiments, the method further includes:
receiving a second MIMO layer number; where the second MIMO layer number is a maximum MIMO layer number that the terminal supports the capability of keeping the power parameter unchanged during switching of the MIMO layer number.

In one embodiment, the second MIMO layer number may be received together with the capability information. For example, the second MIMO layer number may be carried in the capability information, or may be carried by the same signaling as the capability information, or may be carried by different signaling from the capability information. Receiving the second MIMO layer number can be performed before or after receiving the capability information, or simultaneously with receiving the capability information.

In some embodiments, scheduling the terminal based on the capability information includes:
scheduling an uplink MIMO antenna configuration for the terminal based on the capability information.

In this way, the terminal can report whether it can keep its power unchanged during switching of the MIMO layer number, so that the network device can schedule the terminal more accurately according to the terminal capability to improve the efficiency of communication between the terminal and the network device. In addition, the system capacity and coverage can also be improved based on the MIMO layer number switching.

As shown in FIG. 8, an embodiment of the present disclosure provides an information processing method, which is executed by an information processing system. The information processing system includes: a terminal 830 and a network device 832. The method includes:
the terminal sending capability information to the network device at 834; where the capability information indicates whether the terminal has a capability of keeping a power parameter unchanged during switching of a MIMO layer number; in response to scheduling of the network device based on the capability information at 836, the terminal communicating with the network device at 838;
the network device receiving the capability information and scheduling the terminal based on the capability information.

It should be noted that the steps executed by the terminal can refer to the steps and optional implementations corresponding to the aforementioned terminal side, such as FIGS. 2 to 6, and the steps executed by the network device can refer to the steps and optional implementations corresponding to the aforementioned terminal side, such as FIG. 7, which are not repeated here.

The present disclosure provides an information processing method, which may include:
the terminal reporting whether it has the capability of keeping the power level unchanged during switching of the uplink MIMO layer number, the base station determining the maximum power level of the terminal and the supported uplink (UL) MIMO antenna configuration when scheduling the MIMO layer number switching based on the information reported by the terminal.

In some embodiments, the terminal reports whether it has the capability of keeping the power level unchanged during switching of the uplink MIMO layer number. The base station determines the maximum power level of the terminal and the supported UL MIMO antenna configuration when scheduling the MIMO layer number switching based on the information reported by the terminal.

In one embodiment, the terminal indicates through 1-bit information whether it has the capability of keeping the power level unchanged during the switching of the uplink MIMO layer number.

In one embodiment, the terminal reports that the maximum MIMO layer number supported is 4, and the reported power level is PC1.5, which means that when the uplink MIMO layer number is 4, the maximum power that the terminal can support is PC1.5 (i.e., 29 dBm). When the terminal also reports the above-mentioned capability of keeping the power level unchanged during switching of the uplink MIMO layer number, the base station can consider that when the MIMO layer number of the terminal is 2 or 1, its supported maximum power can still be PC1.5 dBm, and it can be considered that the various UL MIMO antenna configurations of the terminal in FIG. 3 can be scheduled. Otherwise, the base station can only schedule the UL MIMO antenna configuration of the terminal in FIG. 4.

In some embodiments, the terminal can report whether it has the capability of keeping the power level unchanged during switching of the uplink MIMO layer number when the MIMO layer number is greater than or equal to 2. When the terminal with the higher number of MIMO layers reports that it has the support capability, the terminal with the lower number of MIMO layers is assumed to have the support reporting capability.

In some embodiments, in order to reduce the number of possible reports, the reported information indicates not only whether the capability of keeping the power level unchanged during switching of the uplink MIMO layer number is available, but also the highest MIMO layer number supporting the capability.

If the number of layers indicating the capability of keeping the power level unchanged during switching of the uplink MIMO layer number is 4, it can be considered that the terminal has the capability when the MIMO layer number is 4 or less, and it can be considered that the terminal does not support the capability when the MIMO layer number is greater than 4.

The embodiment of the present disclosure provides an information processing system, the system including: a terminal and a network device;
where the terminal is used to execute one or more technical solutions on the aforementioned terminal side;
the network device is used to execute one or more technical solutions on the aforementioned network device side.

In the embodiments of the present disclosure, for the steps and related contents executed by the terminal, the relevant contents on the terminal side in the aforementioned embodiments may be referred to; for the steps and related contents executed by the network device, the relevant contents on the network device side in the aforementioned embodiments may be referred to, which are not repeated here.

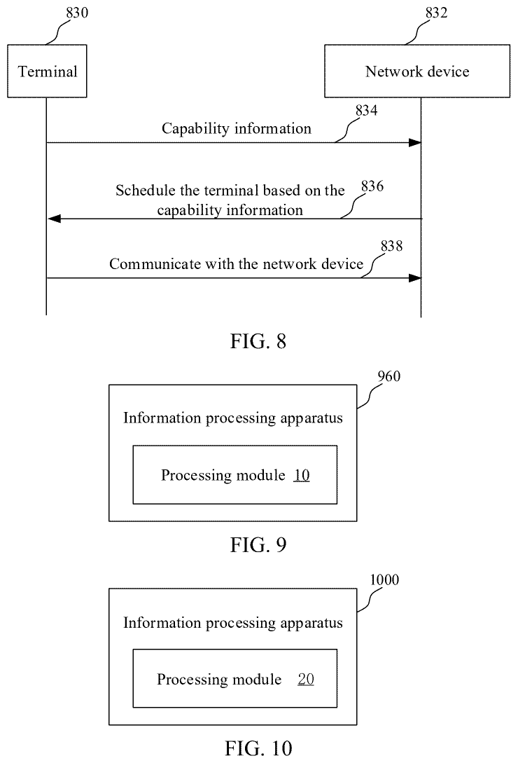

As shown in FIG. 9, an embodiment of the present disclosure provides an information processing apparatus 960, which is applied to a terminal, and the apparatus includes:
a processing module 10, configured to send capability information; where the capability information indicates whether the terminal has a capability of keeping a power parameter unchanged during switching of a MIMO layer number; and communicating with a network device in response to scheduling of the network device based on the capability information.

In one embodiment, the processing module 10 is further configured to:
send a first MIMO layer number; where the first MIMO layer number is a maximum MIMO layer number supported by the terminal; the capability information indicates whether the terminal has the capability of keeping the power parameter unchanged when a MIMO layer number is less than or equal to the first MIMO layer number.

In one embodiment, the processing module 10 is configured to:
when a current MIMO layer number of the terminal is greater than or equal to a given value, send the capability information.

In one embodiment, the capability information further indicates a maximum MIMO layer number that the terminal supports the capability of keeping the power parameter unchanged during the switching of the MIMO layer number.

In one embodiment, the capability information includes:
first capability information indicating that the terminal has the capability of keeping the power parameter unchanged during switching of the MIMO layer number, or second capability information indicating that the terminal does not have the capability of keeping the power parameter unchanged the during switching of the MIMO layer number.

The processing module 10 is configured to:
determine whether the terminal has sent the second capability information or has not sent the first capability information when the maximum MIMO layer number supported is a third MIMO layer number;
in response to the terminal sending the second capability information or not sending the first capability information when the maximum MIMO layer number supported is the third MIMO layer number, send the first capability information when the maximum MIMO layer number currently supported by the terminal is less than the third MIMO layer number and the terminal has the capability of keeping the power parameter unchanged during switching of the MIMO layer number.

In one embodiment, the processing module 10 is further configured to:
in response to the terminal sending the first capability information when the maximum MIMO layer number supported is the third MIMO layer number, not send the capability information when the maximum MIMO layer number currently supported by the terminal is less than the third MIMO layer number.

In one embodiment, when the capability information indicates that the terminal has the capability of keeping the power parameter unchanged during switching of the MIMO layer number, the processing module 10 is further configured to:
send a second MIMO layer number; where the second MIMO layer number is the maximum MIMO layer number that the terminal supports the capability of keeping the power parameter unchanged during switching of the MIMO layer number.

In one embodiment, the processing module 10 is configured to:
determine an uplink MIMO antenna configuration scheduled by the network device based on capability information;
communicating with the network device based on the uplink MIMO antenna configuration.

It should be noted that the processing module 10 of the above-mentioned information processing apparatus can be used to execute any of the steps and optional implementations on the aforementioned terminal side, which are not described in detail here.

As shown in FIG. 10, an embodiment of the present disclosure provides an information processing apparatus 1000, which is applied to a network device. The apparatus includes:
a processing module 20, configured to receive capability information; where the capability information indicates whether the terminal has a capability of keeping a power parameter unchanged during switching of a multiple input multiple output (MIMO) layer number; and schedule the terminal based on the capability information.

In one embodiment, the processing module 20 is further configured to:
receive a first MIMO layer number; where the first MIMO layer number is the maximum MIMO layer number supported by the terminal; and the capability information indicates whether the terminal has the capability of keeping the power parameter unchanged when the MIMO layer number is less than or equal to the first MIMO layer number.

In one embodiment, the capability information is sent by the terminal when the current MIMO layer number is greater than or equal to a given value.

In one embodiment, the capability information further indicates the maximum MIMO layer number that the terminal supports the capability of keeping the power parameter unchanged during the switching of the MIMO layer number.

In one embodiment, the capability information includes:
first capability information indicating that the terminal has the capability of keeping the power parameter unchanged during switching of the MIMO layer number, or second capability information indicating that the terminal does not have the capability of keeping the power parameter unchanged during switching of the MIMO layer number;
the processing module 20 is further configured to:
in response to receiving the first capability information, determine that the maximum MIMO layer number currently supported by the terminal is less than the third MIMO layer number, and the terminal has the capability of keeping the power parameter unchanged during switching of the MIMO layer number; where the network device receives the second capability information or does not receive the first capability information when the maximum MIMO layer number supported by the terminal is the third MIMO layer number.

In one embodiment, the processing module 20 is further configured to:
receive a second MIMO layer number; where the second MIMO layer number is a maximum MIMO layer number that the terminal supports the capability of keeping power parameter unchanged during switching of the MIMO layer number.

In one embodiment, the processing module 20 is configured to:
schedule an uplink MIMO antenna configuration of the terminal based on the capability information.

It should be noted that the processing module 20 of the above-mentioned information processing apparatus can be used to execute any of the steps and optional implementations on the aforementioned terminal side, which are not elaborated here.

In the absence of contradiction, each step in a certain implementation or embodiment can be implemented as an independent embodiment, and the steps can be arbitrarily combined. For example, a solution after removing some steps in a certain implementation or embodiment can also be implemented as an independent embodiment, and the order of the steps in a certain implementation or embodiment can be arbitrarily exchanged. In addition, the optional manners or optional examples in a certain implementation or embodiment can be arbitrarily combined; in addition, the various implementations or embodiments can be arbitrarily combined. For example, some or all steps of different implementations or embodiments can be arbitrarily combined, and a certain implementation or embodiment can be arbitrarily combined with the optional manners or optional examples of other implementations or embodiments.

The embodiment of the present disclosure provides a communication device, including:
a memory for storing instructions executable by a processor(s);
the processor(s), respectively connected to the memory;
where the processor(s) is configured to execute the information processing method provided by any of the aforementioned technical solutions.

The processor may include various types of storage media, which are non-transitory computer storage media that can continue to retain information stored thereon after the communication device loses power.

Here, the communication device includes: a terminal or a network element, and the network element can be any one of the first network element to the fourth network element mentioned above.

The processor may be connected to the memory via a bus or the like, and may be used to read an executable program stored in the memory, for example, at least one of the methods shown in FIG. 2 or FIGS. 5 to 8.

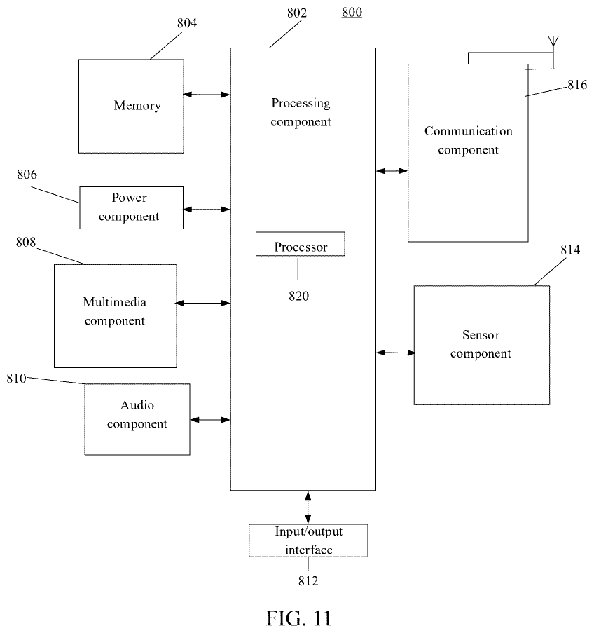

FIG. 11 is a block diagram of a terminal 800 according to an embodiment. For example, the terminal 800 may be a mobile phone, a computer, a digital broadcast user device, a messaging device, a game console, a tablet device, a medical device, a fitness device, a personal digital assistant, etc.

Referring to FIG. 11, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls the overall operation of the terminal 800, such as operations associated with display, phone calls, data communications, camera operations, and recording operations. The processing component 802 may include one or more processors 820 to execute instructions to generate all or part of the steps of the above-mentioned methods. In addition, the processing component 802 may include one or more modules to facilitate the interaction between the processing component 802 and other components. For example, the processing component 802 may include a multimedia module to facilitate the interaction between the multimedia component 808 and the processing component 802.

The memory 804 is configured to store various types of data to support operations at the terminal 800. Examples of such data include instructions for any application or method operating on the terminal 800, contact data, phone book data, messages, pictures, videos, etc. The memory 804 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 806 provides power to various components of the terminal 800. The power component 806 may include a power management system, one or more power supplies, and other components associated with the generation, management, and distribution of power in the terminal 800.

The multimedia component 808 includes a screen that provides an output interface between the terminal 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. When the terminal 800 is in an operation mode, such as a photographing mode or a video mode, the front camera and/or the rear camera may receive an external multimedia datum. Each of the front camera and the rear camera may be a fixed optical lens system or have a focal length and optical zoom capability.

The audio component 810 is configured to output and/or input audio signals. For example, the audio component 810 includes a microphone (MIC), and when the terminal 800 is in an operation mode, such as a call mode, a recording mode, and a voice recognition mode, the microphone is configured to receive an external audio signal. The received audio signal may be further stored in the memory 804 or sent via the communication component 816. In some embodiments, the audio component 810 further includes a speaker for outputting audio signals.

The I/O interface 812 provides an interface between the processing component 802 and peripheral interface modules, such as a keyboard, a click wheel, buttons, etc. These buttons may include but are not limited to: a home button, a volume button, a starting button, and a locking button.

The sensor assembly 814 includes one or more sensors for providing status assessments of various aspects of the terminal 800. For example, the sensor assembly 814 may detect an open/closed status of the device 800, relative positioning of components, such as the display and keypad, of the terminal 800, and the sensor assembly 814 can also detect a position change of the terminal 800 or a component of the terminal 800, a presence or absence of contact between the user and the terminal 800, an orientation or an acceleration/deceleration of the terminal 800, and a temperature change of the terminal 800. The sensor assembly 814 may include a proximity sensor configured to detect the presence of nearby objects without any physical contact. The sensor assembly 814 may also include a light sensor, such as a CMOS or CCD image sensor, for use in imaging applications. In some embodiments, the sensor assembly 814 may also include an acceleration sensor, a gyroscope sensor, a magnetic sensor, a pressure sensor or a temperature sensor.

The communication component 816 is configured to facilitate wired or wireless communication between the terminal 800 and other devices. The terminal 800 can access a wireless network based on a communication standard, such as WiFi, 2G or 3G, or a combination thereof. In one embodiment, the communication component 816 receives a broadcast signal or broadcast associated information from an external broadcast management system via a broadcast channel. In one embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology and other technologies.

In embodiments, the terminal 800 may be implemented with one or more application-specific integrated circuits (ASICs), digital signal processors (DSPs), digital signal processing devices (DSPDs), programmable logic devices (PLDs), field programmable gate arrays (FPGAs), controllers, micro-controllers, microprocessors or other electronic components, for performing the above-described methods.

In embodiments, a non-transitory computer-readable storage medium including instructions is also provided, such as a memory 804 including instructions, which can be executed by the processor 820 of the terminal 800 to generate the above-described methods. For example, the non-transitory computer-readable storage medium may be a ROM, a random access memory (RAM), a CD-ROM, a magnetic tape, a floppy disk, an optical data storage device, etc.

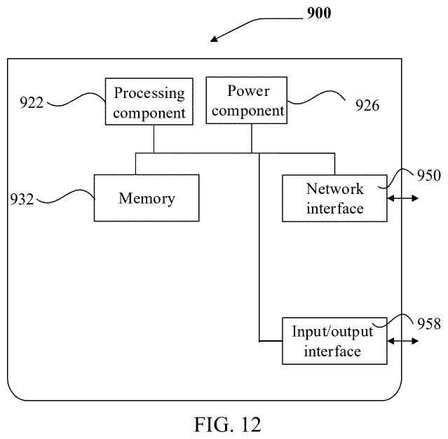

As shown in FIG. 12, an embodiment of the present disclosure shows a structure of a communication device 900. For example, the communication device 900 may be provided as a network node device. The communication device 900 may be the aforementioned base station.

Referring to FIG. 12, the communication device 900 includes a processing component 922, which further includes one or more processors, and a memory resource represented by a memory 932, for storing instructions executable by the processing component 922, such as an application. The application stored in the memory 932 may include one or more modules, each corresponding to a set of instructions. In addition, the processing component 922 is configured to execute instructions to perform any method of the aforementioned method applied to the base station, for example, at least one of the methods shown in FIG. 2 or FIG. 5 to FIG. 8.

The communication device 900 may also include one power component 926 configured to perform power management of the communication device 900, one wired or wireless network interface 950 configured to connect the communication device 900 to a network, and one input/output (I/O) interface 958. The communication device 900 may operate based on an operating system stored in the memory 932, such as Windows Server™, Mac OS X™, Unix™, Linux™, FreeBSD™ or the like.

Those skilled in the art may readily appreciate other embodiments of the present disclosure after considering the specification and practicing the contents disclosed herein. The present disclosure is intended to cover any variations, uses or adaptations of the present disclosure that follow the general principles of the present disclosure and include common knowledge or customary technical means in the art that are not disclosed in the present disclosure. The specification and embodiments are to be considered exemplary only, and the true scope and spirit of the present disclosure are indicated by the appended claims.

It should be understood that the present disclosure is not limited to the exact construction that has been described above and shown in the drawings and that various modifications and changes may be made without departing from the scope thereof. The scope of the present disclosure is limited only by the appended claims.

1. An information processing method, performed by a terminal, the method comprising:
sending capability information, wherein the capability information indicates whether the terminal has a capability of keeping a power parameter unchanged during switching of a multiple input multiple output (MIMO) layer number; and
in response to scheduling of a network device based on the capability information, communicating with the network device.

2. The method according to claim 1, further comprising:
sending a first MIMO layer number, wherein the first MIMO layer number is a maximum MIMO layer number supported by the terminal, and the capability information indicates whether the terminal has the capability of keeping the power parameter unchanged in response to that the MIMO layer number is less than or equal to the first MIMO layer number.

3. The method according to claim 1, wherein sending the capability information comprises:
sending the capability information in response to that a current MIMO layer number of the terminal is greater than or equal to a given value.

4. The method according to claim 1, wherein the capability information further indicates a maximum MIMO layer number that the terminal supports the capability of keeping the power parameter unchanged during switching of the MIMO layer number.

5. The method according to claim 1, wherein in response to that the capability information indicates that the terminal has the capability of keeping the power parameter unchanged during switching of the MIMO layer number, the method further comprises:
sending a second MIMO layer number, wherein the second MIMO layer number is a maximum MIMO layer number that the terminal supports the capability of keeping the power parameter unchanged during switching of the MIMO layer number.

6. The method according to claim 5, wherein communicating with the network device in response to scheduling of the network device based on the capability information comprises:
determining an uplink MIMO antenna configuration scheduled by the network device based on the capability information; and
communicating with the network device based on the uplink MIMO antenna configuration.

7. An information processing method, performed by a network device, the method comprising:
receiving capability information, wherein the capability information indicates whether a terminal has a capability of keeping a power parameter unchanged during switching of a multiple input multiple output (MIMO) layer number; and
scheduling the terminal based on the capability information.

8. The method according to claim 7, further comprising:
receiving a first MIMO layer number, wherein the first MIMO layer number is a maximum MIMO layer number supported by the terminal, and the capability information indicates whether the terminal has the capability of keeping the power parameter unchanged in response to that the MIMO layer number is less than or equal to the first MIMO layer number.

9. The method according to claim 7, wherein the capability information is sent by the terminal when a current MIMO layer number is greater than or equal to a given value.

10. The method according to claim 7, wherein the capability information further indicates a maximum MIMO layer number that the terminal supports the capability of keeping the power parameter unchanged during switching of the MIMO layer number.

11. The method according to claim 7, further comprising:
receiving a second MIMO layer number, wherein the second MIMO layer number is a maximum MIMO layer number that the terminal supports the capability of keeping the power parameter unchanged during switching of the MIMO layer number.

12. The method according to claim 7, wherein scheduling the terminal based on the capability information comprises:
scheduling an uplink MIMO antenna configuration for the terminal based on the capability information.

13.-16. (canceled)

17. A communication device, comprising a processor, a memory, and an executable program stored on the memory and executable by the processor, wherein the processor executes the executable program to perform:
sending capability information, wherein the capability information indicates whether the terminal has a capability of keeping a power parameter unchanged during switching of a multiple input multiple output (MIMO) layer number; and
in response to scheduling of a network device based on the capability information, communicating with the network device.

18. A non-transitory computer storage medium, wherein the computer storage medium stores an executable program, and in response to an execution of the executable program by a processor, the method according to claim 1 is implemented.

19. The communication device according to claim 17, wherein the processor is further configured to:
send a first MIMO layer number, wherein the first MIMO layer number is a maximum MIMO layer number supported by the terminal, and the capability information indicates whether the terminal has the capability of keeping the power parameter unchanged in response to that a MIMO layer number is less than or equal to the first MIMO layer number.

20. The communication device according to claim 17, wherein the processor is further configured to:
send the capability information in response to that a current MIMO layer number of the terminal is greater than or equal to a predetermined value.

21. The communication device according to claim 17, wherein in response to that the capability information indicates that the terminal has the capability of keeping the power parameter unchanged during switching of the MIMO layer number, wherein the processor is further configured to:
send a second MIMO layer number, wherein the second MIMO layer number is a maximum MIMO layer number that the terminal supports the capability of keeping the power parameter unchanged during switching of the MIMO layer number.

22. The communication device according to claim 17, wherein the processor is further configured to:
determine an uplink MIMO antenna configuration scheduled by the network device based on the capability information; and
communicate with the network device based on the uplink MIMO antenna configuration.

23. A communication device, comprising a processor, a memory, and an executable program stored on the memory and executable by the processor, wherein the processor executes the executable program to perform the method according to claim 7.

24. A non-transitory computer storage medium, wherein the computer storage medium stores an executable program, and in response to an execution of the executable program by a processor, the method according to claim 7 is implemented.
